(19) United States
(12) Patent Application Publication
(10) Pub. No.: US 2009/0311393 A1
(43) Pub. Date: Dec. 17, 2009

(54) Food Flavoring System and Method

(76) Inventors: Gary Estess, Von Army, TX (US); Russell Walker, San Antonio, TX (US)

Correspondence Address: STRASBURGER & PRICE, LLP, 901 MAIN STREET, SUITE 4400, DALLAS, TX, 75202, US

(21) Appl. No.: 12/545,227

(22) Filed: Aug. 21, 2009

Related U.S. Application Data
(63) Continuation-in-part of application No. 12/138,354, filed on Jun. 12, 2008.

(51) Int. Cl. A23B 4/048; A23B 4/044

(52) U.S. Cl. 426/312; 99/482

(57) ABSTRACT

The system and method of the present invention includes three parts. Uppermost is a mesh tray on which to rest the food items being cooked. Under the mesh tray is a tray having openings formed therein. Under the tray with openings formed therein is a solid tray. Materials which emit a scent when heated which will permeate the food items being cooked are placed between the bottom of the tray with openings formed therein and the top of the solid tray.

### CROSS-REFERENCE TO RELATED APPLICATION

This application is a continuation-in-part of U.S. patent application Ser. No. 12/138,354 filed Jun. 12, 2008 which is hereby abandoned.

### STATEMENT REGARDING FEDERALLY-FUNDED RESEARCH AND DEVELOPMENT

The invention described in this patent application was not the subject of federally sponsored research or development.

### FIELD

The present invention relates to devices used to cook food items; more particularly, the present invention relates to devices used to cook food items wherein one or more flavors are imparted to the food items during the cooking process by the environment in which the food items are cooked.

### BACKGROUND

Before refrigeration of food items became commonly available, meat or fish was preserved by being exposed to smoke, typically smoke emitted from burning wood. Those consuming the preserved smoked meat or smoked fish quickly learned that the smoke from different types of wood imparted different tastes to the meat or fish. For example, those in the Northern part of the United States used hickory wood to smoke pork items. Those in the Southern part of the United States used the wood from mesquite trees in their smokehouses. Even today, the flavor of the smoke of certain woods in smoked meats is still popular, such as bacon flavored with the smoke produced by burning the wood from apple trees.

After refrigerators became a commonly available household appliance there was little need for the smoking process to preserve either meat or fish. However, some still desired the flavor that the smoking process brought to the flavor of the meat or fish. To meet this desire, some cooks chose for firewood the wood that was once used for smoking. The idea was that the same flavor imparted during the smoking process would be imparted during the cooking process from burning selected types of wood. In some cases this technique was successful and in other cases, the flames from the burning wood either consumed the gases emitted by the wood—which gases carried the desired scent or odor of the wood—or the length of the cooking process did not provide the time needed for the scent or odor from the burning wood to permeate the food item being cooked.

With the growth of suburban living following World War II, many homeowners found it enjoyable to use their yards or patios to cook food items outdoors. This cooking typically took place on outdoor grills. These outdoor grills provided for burning either purchased charcoal or manufactured briquets to provide a heat source. Thus, control over the selection of the type of burning wood on which to cook food items on outdoor grills was lost to convenience. Some users of outdoor grills endeavored to add wood chips from certain types of trees to the charcoal or briquets in their outdoor grills. Unfortunately, those using the technique of adding chips of selected types of wood to charcoal or briquets found that the burning wood chips did not generally impart the desired flavors into the food items being cooked. Further complicating the problem of imparting the desired flavor from the smoke of burning wood into food items being cooked was the use of lighting fluid to ignite the charcoal or briquets. Such lighting fluid at best added a chemical taste to the food items being prepared and at worst produced harmful vapors.

The popularity of outdoor cooking has increased to the point where sophisticated and expensive gas-fueled outdoor grill assemblies now have become a regular product offering at many home improvement stores. Some of these gas fueled outdoor grill assemblies include a built-in container for adding wood chips if the user desires to attempt to add the taste from the smoke of a particular wood to the food items being prepared. Some of these built-in chip containers in outdoor grills actually cause the wood chips to catch on fire and burn during the cooking process. The flames from the burning wood chips either scorch the food items being prepared or impart an unpleasant burned taste to the food instead of the desired flavor heretofore found only in smoked meats.

Some currently available outdoor cooking systems include some type of enclosure for wood chips. These enclosures include large openings formed in their walls to facilitate the flow of air therethough. The openings in the walls of the enclosures are sized to prevent the wood chips from falling out, however, the enclosures designed for containing wood chips will not allow herbs and spices, which release flavoring scents and odors when heated, to be used. For example, if someone desires to impart the flavor of parsley, sage, rosemary or thyme into the food items being cooked, these herbs and spices are sprinkled on the surface of the food item and typically remain only on the surface of the food item; that is, the flavor of the herbs and spices does not permeate the food item. However, if it is desired that the flavor of parsley, sage, rosemary or thyme permeate the food item being cooked, causing the scent or odor produced from these spices to fill the environment in which the food item is being cooked is not possible with the currently available systems.

Accordingly, there is a need in the art for a system and method by which flavors may be imparted into food items during the cooking process by causing materials, which emit odoriferous gases when heated, to be placed in the environment where the food items are being cooked.

### SUMMARY

The system and method of the present invention imparts flavors into food items while the food items are being cooked. Specifically, the disclosed system and method uses the scents or odors given off by different types of woods, seasonings, herbs, spices or other food items which release scents or odors when heated. These scents or odors are added to the environment in which the food items are being cooked. In some cases the scents and odors are carried by visible smoke. In other cases the scents and odors are carried by invisible vapors emitted by the transformation of the volatile oils in seasonings, herbs, spices or other food items from a liquid state to a gaseous state.

The system of the present invention includes three major parts. The first part is a mesh tray on which the food items to be cooked are placed. Formed underneath the mesh tray are a plurality of spacers.

Positioned underneath the mesh tray is top tray having a plurality of openings formed in its planar portion. The top tray is sized to allow for the mesh tray to fit therein.

Positioned underneath the top tray with openings formed therein is a bottom tray having a solid planar portion. When the top tray is nested into the bottom tray a small space is formed between the bottom of the top tray and the top of the bottom tray. It is into this space that the wood chips, seasonings, herbs, spices or other types of food items, which release scents and odors which permeate food items when heated, are placed.

Use of the system described above involves selecting the scent to be released into the environment in which the food items are to be cooked and placing the materials which will produce this scent onto the solid planar portion of the bottom tray. The top tray is then nested on top of the bottom tray. The mesh tray is then placed on the top tray and the food items are placed thereon. The combination of the three trays together with the food items are then positioned over a heat source and covered by a vented hood. The vented hood causes the odoriferous gases to surround the food item being cooked and impart flavor thereto.

Cooking and imparting flavor to the food items being cooked occurs when the combination of the bottom tray, the top tray and the mesh tray are heated to produce an environment of scented or odoriferous gases. The scented or odoriferous gases impart unique flavors to the food items resting on the mesh tray. Accordingly, chefs using the system and method of the present invention are provided with the ability to add an entirely new dimension to the cooking of food items by the creation of a cooking environment which can be tailored to add a desired flavor to food items during the cooking process.

### BRIEF DESCRIPTION OF THE DRAWING FIGURES

A better understanding of the food flavoring system and method of the present invention may be had by reference to the drawing figures wherein:

FIG. 1 is an exploded perspective view of the components included in the food flavoring system of the present invention;

FIG. 2 is a perspective view of a grill assembly using the assembled components of food flavoring system of the present invention;

FIG. 2A is a front elevational view of the grill assembly shown in FIG. 2;

FIG. 2B is a front elevational view of the grill assembly shown in FIG. 2A but with multiple food flavoring systems contained therein; and

FIG. 3 is a perspective view of a stove using the assembled food flavoring system of the present invention.

### DESCRIPTION OF THE EMBODIMENTS

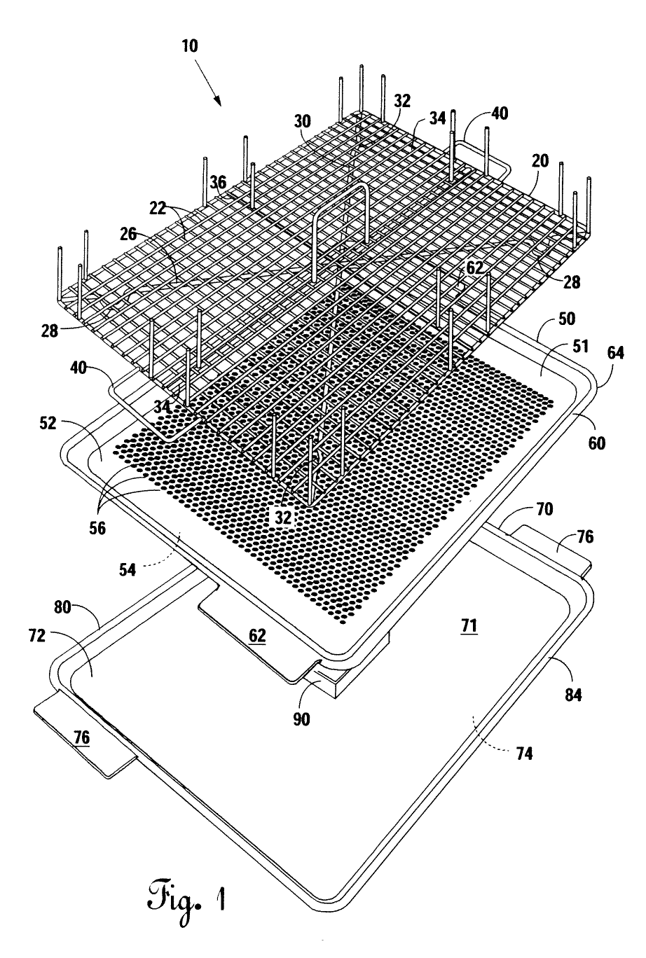

As shown in FIG. 1, the food flavoring system of the present invention 10 includes three parts. The first part is a mesh tray 20 on which food items are placed for cooking. The second part is a top tray 50 sized to support the mesh tray 20. A plurality of small openings 56 are included in the top tray 50. The third part is a solid bottom tray 70. The top tray 50 nests into the bottom tray 70 so that a space is formed between the top 72 of the bottom tray 70 and the bottom 54 of the top tray 50.

It is into the space between the top 72 of bottom tray 70 and the bottom 54 of the top tray 50 that items such as wood chips or seasonings, which omit a scent or an odor when heated, are placed. The scent or odor fills the environment surrounding the food items while they are being cooked. The absorption of the scent or odor by the food items during the cooking process changes their flavor. Those consuming the cooked food items then experience a flavor associated with the scent or odor determined by the selection of the items to be placed in the space between the bottom tray and top tray. A more detailed description of each part of the disclosed food flavoring system follows.

The mesh tray 20 is a substantially rigid mesh tray. In the preferred embodiment of the disclosed invention, the substantially rigid mesh tray is formed from wire woven into an open weave fabric. The woven wire is placed within a frame 24 to enable its utility. While a wire mesh forms the preferred embodiment, bars or thick wire 22 extending in a single direction across the frame 24 as shown in FIG. 1 may also be used. Alternatively, the mesh tray may be formed from a single piece of metal.

On either end of the frame is a handle 40. The handle 40 may be made of a heat-resistant metal or the handle may be covered with a thermal-insulating material. In the illustrated embodiment, underneath the open mesh fabric is placed an “X”-shaped support formed by two wires 26, 30, each wire 26, 30 being attached to opposing corners of the frame 24. The wires include a U-shaped bend 28, 32 near the corners of the frame 24. The U-shaped bend 28, 32 acts as a spacer which holds the mesh tray 20 above the top surface 52 of the top tray 50. Alternatively, separate spacers may be used under the mesh tray 20.

If desired a handle 34 may also be placed in the middle of the substantially rigid mesh tray 20 for placing the mesh tray 20 into the top tray 50 or removing the mesh tray 20 from the top tray 50.

Optionally, the mesh tray 20 may include spikes 36 placed around its perimeter or in its central portion. The spikes 36 may preferably extend in a substantially perpendicular direction from the plane of the mesh tray 20. Some users may find the spikes 36 useful for holding food items therebetween in a substantially vertical orientation when the user desires not to lay the food items on the top of the mesh tray 20. Alternatively, the spikes 36 may be caused to pass through a sausage, or a hot dog. Others may wish to use the spikes 36 as a skewer to hold the ingredients of shish-kabob combinations. Interestingly, the distance of the food item from the top of the substantially rigid mesh tray 20 makes little difference in the rate at which the food item is cooked.

The top or first tray 50 is similar to an ordinary cookie sheet, however, a plurality of small openings 56 have been formed in its planar portion 51. The small openings 56 are sized to restrict the flow of air to the wood chips or spices placed on the bottom or second tray 70 to prevent the wood chips or spices from catching fire.

The planar portion 51 has a top surface 52 and a bottom surface 54. Surrounding the perimeter of the planar portion 51 is a side wall 60. Extending outwardly from the top of the side walls 60 at opposing ends are tabs or handles 62 to facilitate lifting the top tray 50. As with the handles 40 on the ends of the substantially rigid mesh tray 20 the tabs or handles 62 may be made from a heat-resistant metal or covered with a thermal-insulating material. The top of the side walls 60 may terminate in a rolled rim or lip 64 to assure that the user's hands are not damaged by any sharp metal edges.

The bottom or second tray 70 is similar to the top or first tray 50; however, the second tray 70 has no openings formed in its planar portion 71. The planar portion 71 has an upper surface 72 and a lower surface 74 and a side wall 80 formed therearound. As with the first or top tray 50, tabs or handles 76 may be formed at either end to facilitate lifting. Such tabs or handles 76 may be formed from a heat-resistant metal or be covered with a thermal-insulating material. A rolled rim or lip 84 may be formed at the top of the side wall 80 to prevent cuts on the user's hand from sharp metal edges.

Optionally, the bottom or second tray 70 may include a walled receptacle 90 positioned in the midst thereof. Specialty food items such as lemons, oregano, or balsamic vinegar may be placed in the walled receptacle 90 if such scents or odors are desired to be imparted into the food items being cooked. Alternatively, the walled receptacle may be placed on the top tray 50 if the contents are large enough to not pass through the openings 56. In the preferred embodiment the mesh tray 20, the top tray 50 and the bottom tray 70 are made from aluminum. The walled receptacle 90 on the bottom tray 70 is made of stainless steel as some salts used in food preparation react with certain metals, such as aluminum, when heated. Alternatively, all trays may be made from iron or stainless steel. Iron or stainless steel trays work particularly well over wood fires.

Users of the system 10 will begin their preparation of food items by selecting the materials to be placed in the bottom tray 70. Such items may include one or more types of wood chips commonly used in cooking such as hickory or mesquite. The wood chips may then be sprinkled with some type of seasoning such as parsley, sage, rosemary or thyme. Alternatively, only one or more seasonings may be used and the wood chips eliminated entirely. To add moisture to the food items being cooked, water, a light oil or both may be added to the materials placed in the bottom tray or second tray 70 or placed in the walled receptacle 90. It has been found that only small amounts of wood chips or other seasonings are required.

The top or first tray 50 nests in the bottom or second tray 70 so that a space is formed therebetween. As indicated above the space contains the wood chips, seasoning, herbs, spices, or a combination thereof.

The substantially rigid mesh tray 20 is then placed into the top or first tray 50. The spacers 28, 32 on the bottom of the mesh tray 20 hold its upper surface away from the top surface 52 of the top or first tray 50. Food items are placed on the top of the mesh tray 20.

The cooking process is typically initiated by first causing the system to be placed over the hottest portion of the heating element or with the heating element at a high setting. When visible smoke appears the system is moved to a cooler spot or the heating element is turned down. Other users will realize that seeing visible smoke is not necessary in that certain materials release their scents or odors when heated but do not produce visible smoke. Such scents or odors are thought to be contained in the vapors formed when heat causes volatile oils to transform from a liquid to a gaseous state.

As will be understood by those of ordinary of ordinary skill in the art, a limited or restricted amount of air will enter and exit through the openings 56 in the planar portion 51 of the first tray 50. This restricted air flow is key to the operation of the present invention. Specifically, when heated the materials in the bottom tray 70 will emit scented or odoriferous gases. However, because of the limited air flow the materials in the bottom tray 70 will not catch on fire or will even be reduced to ashes. The wood chips will turn into a hard charcoal-like substance. Other items will just lose their moisture content and dry out or become brittle.

In actual operation, food cooked on the disclosed system has the appearance of being cooked in a convection oven. It is believed that the combination of the top tray 50 and the bottom tray 70 with the wood chips or flavorings there between acts as a heat insulator and causes the flow of heat to surround the food items being cooked.

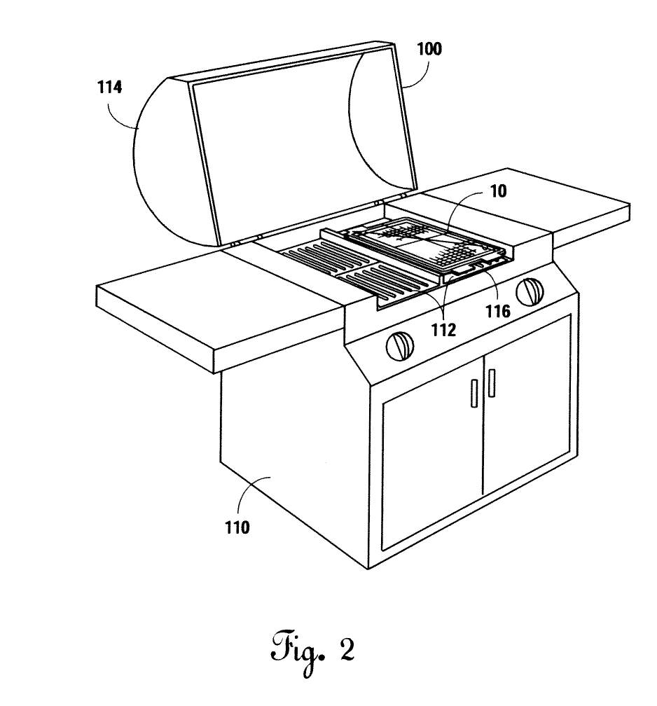

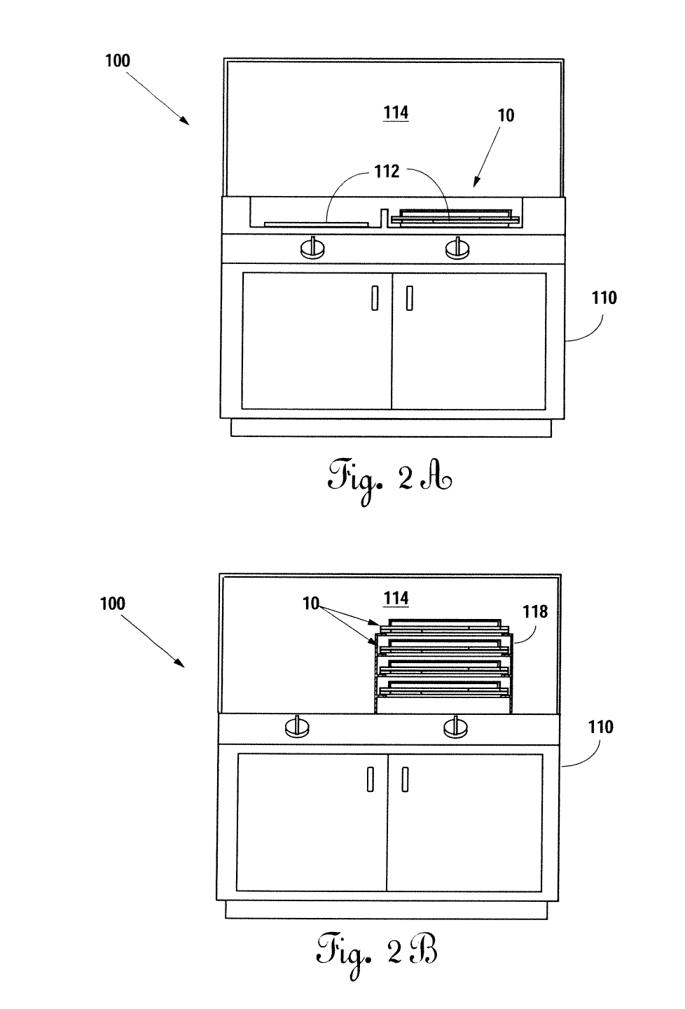

As shown in FIGS. 2, 2A, and 2 B the system of the present invention may be shaped for use with an outdoor grill assembly 100. Such outdoor grill assemblies 100 typically including a housing 110 which contains a heating element (not shown). Over the heating element (not shown) is a grate 112 on which food items are normally placed. Hingedly attached to the housing 110 is a lid or hood 114. The system of the present invention 10 may be a part of such an outdoor grill assembly. Specifically, a recess 116 may be formed in the grate over the heating element to accommodate one or more of the disclosed food flavoring systems side by side. Alternatively, a rack 118 may be placed on the grate 112 so that multiple systems 10 accordingly to the present invention may be placed vertically one over the other. In such case, it has been found that wood chips, seasonings, herbs, spices, or other food items need only be placed in one of the food flavoring systems 10.

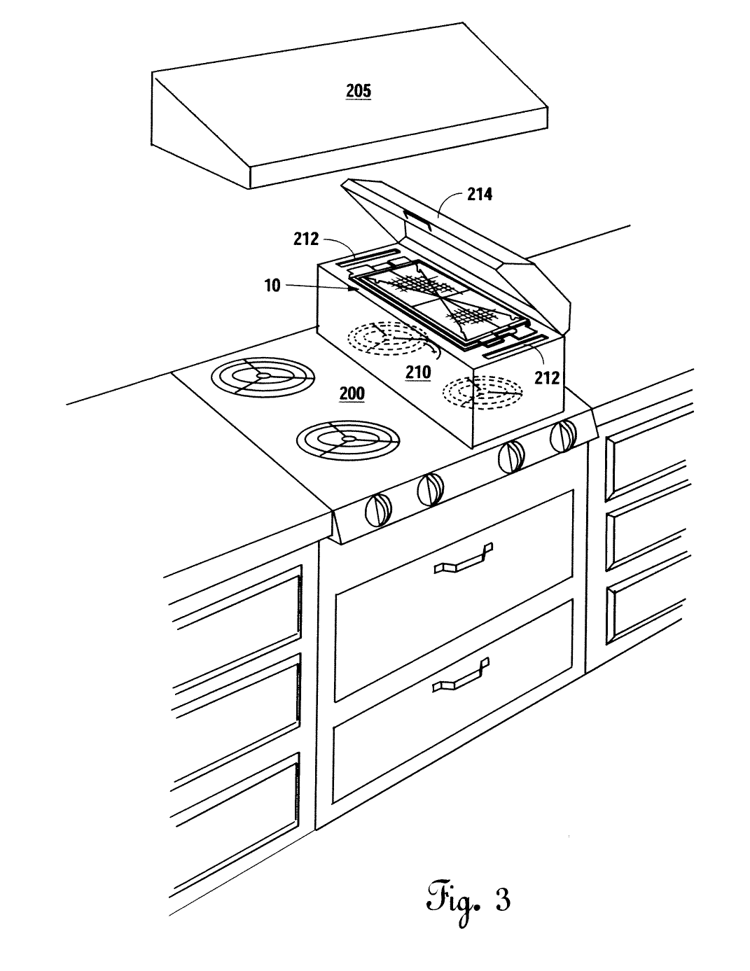

As shown in FIG. 3, the system of the present invention 10 may also be used on a stove 200 in an indoor kitchen where a ventilation hood or evacuation fan 205 is installed near the stove 200. Herein a platform 210 is placed on the stove burners. The platform 210 includes air vents 212 passing therethough. The food flavoring system 10 of the present invention is placed on top of the platform 210. Placed over the food flavoring system is a cover or hood 214. Air drawn through the vents 212 in the platform 210 is sufficient to pick up the scents from the smoldering wood chips, seasonings, herbs, spices or their items placed in the food flavoring system and permeate the environment in which the food items are being cooked. Accordingly, the present invention may be used in restaurants desiring to distinguish themselves by having uniquely flavored foods on their menu.

Users of the disclosed system and method will discover the following advantages. When meat is cooked, the cooked meat comes out juicy and not dry. If barbecue sauce is placed on the meat item being cooked, the barbecue sauce will not caramelize on the surface of the meat item. The exterior surface of the meat remains tender during the cooking process. No black or crusty portions appear on the exterior of the cooked meat item. There is no need to repeatedly turn the meat over during the cooking process. It has been observed that cuts of meat either retain their original size or grow slightly during the cooking process.

Grease or hot liquids falling from the food items being cooked do not drop onto the heating element where they may flare and produce flames which either burn the outside of the item being cooked or cause uncontrolled cooking temperature variations. Instead, grease and hot liquids fall onto the top tray 50 where they may either be turned into steam or vapor by failing on a heated surface or they may pass through the openings 56 in the top tray 50 and fall into the bottom tray 70. Catching this grease and hot liquid in the bottom tray 70 also prevents the grease or hot liquid from falling into the inside of a grill and corroding or eventually causing a hole to form in a grill housing. Accordingly, some users have found that the grease guard placed over the heating element in many outdoor grills may be removed when using the disclosed system 10.

Users of the disclosed system and method have found that most food items cook faster than when simply being placed on a grate over a heat source. In addition, thawing of frozen foods before cooking is not generally necessary as frozen foods may be placed directly on the substantially rigid mesh tray 20. When vegetable items are cooked, such as a stuffed pepper, there is no need to place foil under the vegetable item to keep the bottom surface of the pepper from being burned or scorched.

Following use of the disclosed system and method 10, users are able to use the system again with out changing the materials used to impart flavor to the food items being cooked as the materials are not generally consumed during the cooking process. Clean up is simplified as the materials in the bottom tray do not produce flames or turn to ash; rather, as indicated above, the materials in the bottom tray 70 just dry out and are easily dumped into in a trash receptacle. The mesh tray 20, the top tray 50 and the bottom tray 70 are washable in a dishwasher after use.

While the smoker device or disclosed system and method has been disclosed by a description of its preferred and alternate embodiments, those of ordinary skill in the art will understand that numerous modifications may be made to the disclosed system and method without departing from the present invention. Such modifications shall be included within the scope and meaning of the appended claims.

What is claimed is:

1. A system for imparting flavor into food items during cooking, said system comprising:
a substantially rigid mesh tray having an upper surface on which to rest the food items being cooked and a plurality of spacers extending from the bottom surface thereof;
a first tray having an upper surface and a bottom surface, said first tray constructed and arranged to receive said rigid mesh tray, said first tray having a plurality of openings formed therethrough;
a second tray having a upper surface and a bottom surface, said second tray constructed and arranged to receive said first tray and to form a space between the top surface of said second tray and said bottom surface of said first tray;
said space between said top surface of said second tray and said bottom surface of said first tray being large enough to accommodate material which will emit scented gases when heated, which scented gases will impart flavor to the food items on said substantially rigid mesh tray.

2. The system as defined in claim 1 wherein said first tray and said second tray have a sidewall formed about their perimeters.

3. The system as defined in claim 2 wherein a pair of handles extends from opposing positions on said side walls of said first tray and said second tray.

4. The system as defined in claim 1 wherein said rigid mesh tray includes a plurality of spikes extending from said upper surface of said rigid mesh tray.

5. The system as defined in claim 1 wherein said second tray includes a walled receptacle with said space between said top surface of said second tray and said bottom surface of said first tray.

6. The system as defined in claim 1 wherein said second tray receives liquid falling from the food items and passing through the openings in said first tray during the cooking process.

7. The system as defined in claim 1 wherein the flow of air into the space between said top surface of said second tray and said bottom surface of said first tray is through said openings in said second tray.

8. A method for creating an environment for cooking food items in which odiferous gases are used to impart flavor to said food items during the cooking process, said method comprising the steps of:
placing materials which emit odoriferous gases when heated onto a tray having a solid substantially planar surface;
covering said tray having a solid substantially planar surface with a tray having a plurality of openings formed therethrough;
placing a substantially rigid mesh tray over said tray having a plurality of openings formed therethrough:
placing food items on said substantially mesh tray;
placing the combination of said tray having a solid planar surface, said tray having a plurality of openings formed therethrough, said substantially rigid mesh tray, and said food items over a heat source;
whereby said materials which emit odoriferous gases when heated within the space between said having a solid substantially planar surface and said tray having a plurality of openings formed therethrough thereby imparting the flavor carried by said odoriferous gases into said food items being cooked.

9. The method as defined in claim 8 wherein said substantially rigid mesh tray includes one or more spikes extending in a substantially perpendicular direction from said upper surface of said substantially rigid mesh tray.

10. The method as defined in a claim 8 further including the step of placing different types of materials which emit odoriferous gas when heated within a walled receptacle placed in the space between said top surface of said second tray and the said bottom surface of said first tray.

11. A grill for cooking food items, said grill comprising:
a substantially enclosed heating element;
a rack constructed and arranged for placement over said substantially enclosed heating element;
a cover sized for placement over said rack;
at least one smoker device for placement on said rack, said smoker device including:
a substantially rigid mesh tray having an upper surface on which to rest the food items being cooked and a plurality of spacers extending from the bottom surface thereof;
a first tray having an upper surface and a bottom surface, said first tray constructed and arranged to receive said rigid mesh tray;
a second tray having an upper surface and a bottom surface, said second tray constructed and arranged to receive said first tray and to form a space between the top surface of said second tray and said bottom surface of said first tray;
said space between said top surface of said second tray and said bottom surface of said first tray being large enough to accommodate material which will emit smoke when heated to impart flavor the food items placed on said substantially rigid mesh tray.

12. The grill as defined in claim 11 wherein said first tray and said second tray have a sidewall formed about their perimeters,

13. The grill as defined in claim 12 wherein a pair of handles extends from opposing positions on said side walls of said first tray and said second tray.

14. The grill as defined in claim 11 wherein said substantially rigid mesh tray includes a plurality of spikes extending in a substantially perpendicular direction from said upper surface of said substantially rigid mesh tray.

15. The grill as defined in claim 11 wherein said second tray includes a walled receptacle within said space between said top surface of said second tray and said bottom surface of said first tray.

16. The grill as defined in claim 11 wherein said second tray receives liquid falling from said food items and passing through the openings in said first tray during the cooking process.

17. The grill as defined in claim 11 wherein the space for the flow of air into the space between said top surface of said second tray and said bottom surface of said first tray is through said openings in said first tray.

18. A device for imparting flavor into food items while cooking the food items over one or more of the heating elements on the top of a stove, said device comprising:
a vented platform constructed and arranged for placement over the one or more heating elements on the top of the stove;
a vented cover sized for placement over said platform;
at least one smoker device for placement on said platform, said smoker device including:
a substantially rigid mesh tray having an upper surface on which to rest the food items being cooked and plurality of spacers extending from the bottom surface thereof;
a first tray having an upper surface and a bottom surface, said first tray constructed and arranged to receive said substantially rigid mesh tray;
a second tray having an upper surface and a bottom surface, said second tray constructed and arranged to receive said first tray and to form a space between the top surface of said second tray and said bottom surface of said first tray;
said space between said top surface of said second tray and said bottom surface of said first tray being large enough to accommodate material which will emit smoke when heated to impart flavor to the food items placed on said substantially rigid mesh tray.

19. The device as defined in claim 18 wherein said rigid mesh tray includes a plurality of spikes extending in a substantially perpendicular orientation from said upper surface of said substantially rigid mesh tray.

20. The device as defined in claim 18 wherein said second tray includes a walled receptacle within said space between said top surface of said second tray and said bottom surface of said first tray.
